(19) United States
(12) Patent Application Publication
(10) Pub. No.: US 2022/0092902 A1
(43) Pub. Date: Mar. 24, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Toshiki KASHIWAKURA, Tokyo-to (JP); Osamu IZUMIDA, Nagoya-shi (JP); Xin JIN, Nagoya-shi (JP); Hideo HASEGAWA, Nagoya-shi (JP); Yoh IKEDA, Konan-shi (JP); Tomoya MAKINO, Kariya-shi (JP)

(73) Assignee: TOYOTA JIDOSHA KABUSHIKI KAISHA, Toyota-shi (JP)

(21) Appl. No.: 17/476,096

(22) Filed: Sep. 15, 2021

(30) Foreign Application Priority Data
Sep. 18, 2020 (JP) 2020-157857

(51) Int. Cl. G07C 9/25; G07C 9/27; G06F 21/32; G06F 21/40

(52) U.S. Cl. CPC G07C 9/257; G06F 21/40; G06F 21/32; G07C 9/27

(57) ABSTRACT

In an information processing apparatus, a controller acquires biometric information of a user at a time of reception for use of the facility by the user. Furthermore, the controller associates the biometric information of the user with information indicating the user. Moreover, the controller registers the biometric information of the user as a key to be used in the facility.

### CROSS REFERENCE TO THE RELATED APPLICATION

This application claims the benefit of Japanese Patent Application No. 2020-157857, filed on Sep. 18, 2020, which is hereby incorporated by reference herein in its entirety.

### BACKGROUND

### 1. Technical Field

The present disclosure relates to an information processing apparatus, an information processing method, and a non-transitory storage medium.

### 2. Description of the Related Art

Conventionally, there is a management system including a terminal and a reception management apparatus that is connected to the terminal over a network. The terminal is installed at a mobile accommodation facility. The reception management apparatus includes an output unit that outputs, to the terminal, a check-in guide for the mobile accommodation facility, an output pattern determination unit that determines, according to a predetermined condition, an output pattern indicating contents of output regarding the check-in guide to be output by the output unit, and an output controller that controls output of the check-in guide by the output unit based on the output pattern determined by the output pattern determination unit (for example, Japanese Patent Laid-Open No. 2019-121199).

### SUMMARY

The present disclosure is aimed at providing an information processing apparatus, an information processing method, and a non-transitory storage medium that make handing over of a key to be used in a facility unnecessary.

A mode of the present disclosure is an information processing apparatus including a controller configured to acquire biometric information of a user at a time of reception for use of a facility by the user, associate the biometric information of the user with information indicating the user, and register the biometric information of the user as a key to be used in the facility.

A mode of the present disclosure may include at least one of an information processing method, an information processing system, a program, and a recording medium recording the program that are provided with same characteristics as the information processing apparatus.

According to the present disclosure, handing over of a key to be used in a facility may be made unnecessary.

### BRIEF DESCRIPTION OF THE DRAWINGS

FIG. 1 is a schematic diagram of an information processing system according to an embodiment;

FIG. 2 is a diagram illustrating an example of a facility;

FIG. 3 illustrates an example configuration of a server;

FIG. 4 illustrates an example data structure of a table that is managed by the server;

FIG. 5 illustrates an example configuration of a terminal;

FIG. 6 is a flowchart illustrating an example process that is performed by a processor of the server;

FIG. 7 is a flowchart illustrating an example process by a processor of a terminal for reception;

FIG. 8 is a flowchart illustrating an example process by the processor of the server performing exchange with the terminal for reception;

FIG. 9 is a flowchart illustrating an example process by a processor of a terminal for biometric authentication;

FIG. 10 is a flowchart illustrating an example process by the processor of the server performing exchange with the terminal for biometric authentication;

FIG. 11 is a flowchart illustrating an example process by a processor of the terminal for biometric authentication; and

FIG. 12 is a flowchart illustrating an example process by the processor of the server performing exchange with the terminal for biometric authentication.

### DESCRIPTION OF THE EMBODIMENTS

An information processing apparatus according to an embodiment includes a controller configured to acquire biometric information of a user at a time of reception for use of a facility by the user, associate the biometric information of the user with information indicating the user, and register the biometric information of the user as a key to be used in the facility.

With the information processing apparatus, the biometric information of the user and information indicating the user (such as personal information of the user or a reservation information of the user for the facility) are associated with each other at the time of reception of the user at the facility. Then, the biometric information of the user is registered as a key to be used in the facility. Accordingly, a key to be used in the facility does not have to be handed over to the user. Furthermore, the user does not have to carry a key when using the facility.

In the following, an information processing apparatus, an information processing method, and a program according to an embodiment will be described with reference to the drawings. The configuration of the embodiment is an example, and the present disclosure is not limited to the configuration of the embodiment.

<Configuration of Information Processing System>

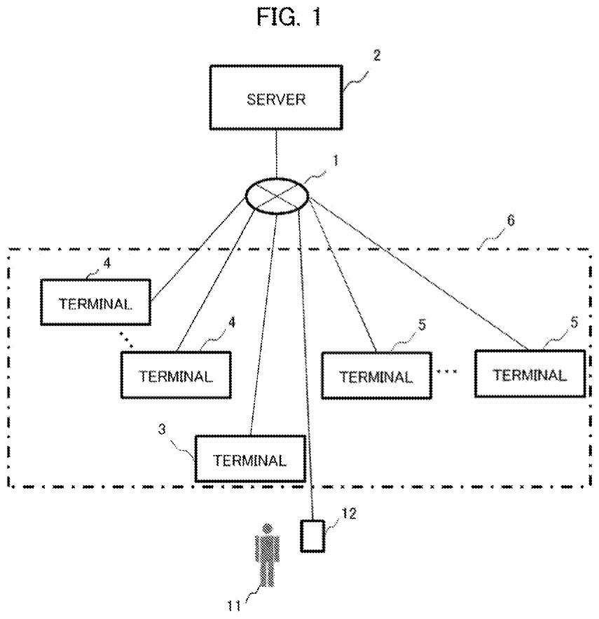

FIG. 1 is a schematic diagram of an information processing system according to the embodiment. In FIG. 1, the information processing system includes a server 2, a terminal 3, a terminal 4, and a terminal 5 that are connected to a network 1. The terminal 3, the terminal 4, and the terminal 5 are each used in a facility 6.

For example, the network 1 is a public communication network such as the Internet, and a wide area network (WAN) or other communication networks may be adopted. The network 1 may also include a cellular network such as long term evolution (LTE) or 5G, or a wireless network (wireless routing) such as a wireless local area network (LAN; Wi-Fi included) or BLE.

The terminal 3 is a terminal for reception of a user 11 who is to use the facility 6. The terminal 4 is a terminal used to unlock a locked part in the facility 6. The terminal 5 is a terminal that is used such that the user 11 may acquire a product or a service provided in the facility 6. The terminal 4 and the terminal 5 are used for authentication (biometric authentication) that uses biometric information of the user 11. One or more of each of the terminals 3, the terminals 4, and the terminals 5 may be provided in the facility 6. In the example illustrated in FIG. 1, one terminal 3, a plurality of terminals 4, and a plurality of terminals 5 are illustrated.

The locked part in the facility 6 is at least one of a door, a gate, a window, equipment (such as a locker), and a tool (a rental bicycle, sporting goods such as a racket, a camping item, etc.). However, the locked part is not limited thereto. Types of products or services are not restricted so long as appropriate provision to the user 11 in the facility 6 is possible. A key may be used to notify a clerk of the facility 6 that a result of biometric authentication is success and authenticity is proven, and to inform the user 11 that a product or a service can be provided.

The server 2 is an example of “information processing apparatus”. The server 2 manages information about the user 11 who uses the facility 6. Information about the user 11 includes reservation information of the user 11 for the facility 6, information about the key to be used by the user 11 in the facility 6, and information about a cost and a fee (a charge) occurring in the facility 6 in relation to the user 11. The information about the user 11 is managed using identification information (a user ID) of the user 11.

At the facility 6, the biometric information of the user 11 is used as the key. The biometric information includes a fingerprint, a vein, an iris, a face and the like. Biometric authentication is performed using the biometric information of the user 11, and unlocking of the locked part or provision of a product or a service is determined at a time of success of authentication.

In the case of using the facility 6, the user 11 uses a terminal 12 of the user 11, and transmits reservation request information to the server 2 over the network 1. The reservation request information includes personal information of the user 11. Personal information may include a name, an address, contact information (such as a telephone number, a short message address, and an email address), and a payment method for a fee, such as a credit card number. Furthermore, the reservation request information may include a date of use, and a start time and an end time of use of the facility 6. However, in the case where the start time and the end time of use of the facility 6 are set in advance, the start time and the end time of use do not have to be included in the reservation request information.

The server 2 registers and manages the reservation information in a case where a reservation for the facility 6 is completed. At the time of reception (check-in) of the user 11 at the facility 6, the terminal 3 acquires the biometric information from the user 11, and transmits the same to the server 2 over the network 1. The server 2 associates the reservation information as the information indicating the user with the biometric information, and registers the biometric information as the key of the user 11. The server 2 registers the biometric information as a key for unlocking the locked part in the facility 6, and a key to be used for provision of a product or a service that is provided in the facility 6. When the user 11 is using the facility 6, unlocking or provision of a product or a service is performed based on biometric authentication using the terminal 4 or the terminal 5. Additionally, provision of products and services using the key (the biometric information) is optional.

<Facility>

The facility 6 may be an accommodation facility, a fitness facility, a play facility (a recreational facility), an entertainment facility, a library, a museum, a concert hall, and the like. The accommodation facility may be a hotel, a Japanese inn, a bed and breakfast, a guesthouse, a campsite, and the like. The fitness facility and the play facility may be a gym, an athletic field, a ball game field, a tennis court, a swimming pool, a bowling alley, a billiard hall, a fitness center, a mahjong parlor, a pachinko parlor, a game arcade, and the like. The entertainment facility may be a bar, a dance hall, an Internet cafe, a karaoke bar, a live music club, and the like.

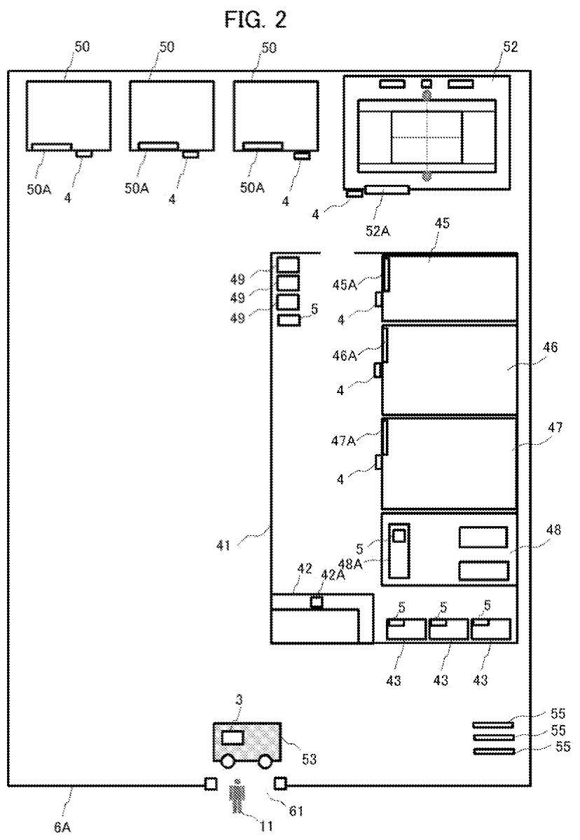

FIG. 2 is a diagram illustrating an example of the facility 6. FIG. 2 illustrates a facility 6A that is an example of the facility 6. The facility 6A is an accommodation facility. A multipurpose hall (an entrance hall) 41, a plurality of guesthouses (accommodation buildings) 50, and a tennis court 52 are provided on premises of the facility 6A. The tennis court 52 is an example of a fitness facility. The plurality of guesthouses 50 may be a plurality of guest rooms in a building.

A vehicle 53 that carries the user 11 to a desired location travels on the premises. The vehicle 53 travels to the user 11 who is at an entrance 61 of the facility 6A. The terminal 3 is provided in the vehicle 53, and reception of the user 11 using the terminal 3 (registration of the biometric information (key) of the user 11) may be performed while the vehicle 53 is carrying the user 11 to the guesthouse 50 where the user 11 is to stay. The vehicle 53 may travel by being driven by a person, or by autonomous driving. Additionally, a travel range of the vehicle 53 is not limited to within the facility 6A, and the vehicle may travel outside the premises of the facility 6A to, for example, a predetermined pick-up position including a station or an airport to pick up the user 11.

A door 50A that is locked is provided at the entrance of the guesthouse 50, and the terminal 4 is provided near the door 50A. The door 50A may be unlocked by biometric authentication using the terminal 4. Furthermore, a gate 52A that is locked is provided at an entrance of the tennis court 52, and the terminal 4 is provided near the gate 52A. The user 11 who uses the tennis court 52 may unlock the gate 52A by biometric authentication using the terminal 4.

Furthermore, inside the building of the multipurpose hall 41, reception (front desk) 42, a changing room 45, a communal bathroom 46, a lounge 47, a shop 48, an automatic vending machine 43, and a locker 49 are provided. Insides of the changing room 45, the communal bathroom 46, and the lounge 47 are divided into spaces for men and women.

A terminal 42A that is capable of operating as the terminals 3 and 4 is provided at the reception 42, and the terminal 42A is operated by a clerk of the facility 6A. A reception (check-in) procedure for the user 11 may be performed also at the reception 42. Furthermore, the reception 42 is used also as a place where products and services are provided to the user 11. Additionally, cost of using the facility 6A, including purchase fees for products and services in the facility 6A, is paid with a credit card using a credit card number. Accordingly, the user 11 does not have to perform a check-out procedure.

For example, reception for rental of a bicycle 55 is performed at the reception 42, and the clerk may provide permission for rental of the bicycle 55 to the user 11 by using the terminal 42A at a time of success of biometric authentication using the terminal 42A. In the case of providing permission, the clerk informs the user 11 of a key number of the bicycle 55. The bicycle 55 is provided with a lock to which a number is to be input, and the user 11 may unlock the lock of the bicycle 55 by inputting the key number that the user 11 is informed of. Moreover, the reception 42 serves also as a kiosk, and settlement of purchase of a product is performed using biometric authentication by the terminal 42A. The kiosk sells souvenirs, household supplies, food items, medicines, and tennis balls, and provides a rental service for rackets and balls.

Doors 45A, 46A, and 47A are provided at the changing room 45, the communal bathrooms 46, and the lounge 47, respectively, and unlocking of each of the doors 45A, 46A, and 47A is performed by biometric authentication using the terminal 4 provided near each of the doors 45A, 46A, and 47A.

For example, the shop 48 is a shop that provides a massage service to users of the facility 6A including the user 11, and the terminal 5 is placed on a reception counter 48A. At the time of reception for the massage service, a clerk performs biometric authentication of the user 11 using the terminal 5, and performs settlement of payment for the massage service.

Furthermore, the automatic vending machine 43 is provided in the multipurpose hall 41, and purchase of a product is performed by biometric authentication using the terminal 5. When biometric authentication succeeds, purchase buttons for all the products in the automatic vending machine 43 are placed in an accepting state, and a product that is selected by pressing of a button by the user 11 is dispensed from an outlet for products. At this time, the cost for the product selected by the user 11 is charged by the terminal 5.

Furthermore, the locker 49 is provided in the multipurpose hall 41, and rental of the locker 49 is performed by biometric authentication using the terminal 5. The user 11 inputs, to the terminal 5, the number of a locker that is not used, and performs biometric authentication. When biometric authentication succeeds, a lock of a door of the locker 49 corresponding to the number is unlocked, and the user 11 is enabled to put his/her belongings therein. The locker 49 is rented for a fee or for no fee, and if for a fee, a charge process is performed by the terminal 5. In the following, each of configurations of the server 2, the terminal 3, the terminal 4, and the terminal 5 will be described in detail.

<Configuration of Server>

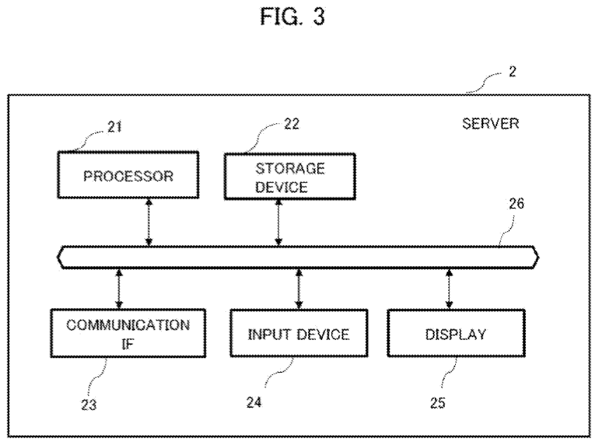

FIG. 3 illustrates an example configuration of the server 2. The server 2 may be configured using a general-purpose information processing apparatus (computer) such as a personal computer (PC) or a workstation, or a dedicated information processing apparatus such as a server machine. The server 2 includes a communication function, and is capable of connecting to the network 1 in a wired or wireless manner.

The server 2 includes a processor 21 as a processing unit or a controller, a storage device (memory) 22, a communication interface 23 (a communication IF 23), an input device 24, and a display 25 that are interconnected by a bus 26. The server 2 may be one information processing apparatus, or a collection (a cloud) of two or more information processing apparatuses.

The memory 22 includes a main memory and an auxiliary memory. The main memory is used as a storage area for programs and data, a program development area, a program work area, a buffer area for communication data, and the like. The main memory is a random access memory (RAM) or a combination of the RAM and a read only memory (ROM). The auxiliary memory is used as a storage area for data and programs. For example, as the auxiliary memory, a non-volatile storage medium such as a hard disk, a solid state drive (SSD), a flash memory, or an electrically erasable programmable read-only memory (EEPROM) may be used.

The communication IF 23 is a circuit that performs communication processing. For example, the communication IF 23 is a network interface card (NIC). Furthermore, the communication IF 23 may be a wireless communication circuit that performs wireless communication (such as LTE, 5G, wireless LAN (Wi-Fi), BLE or the like). Moreover, the communication IF 23 may include both a circuit that performs communication processing in a wired manner, and a wireless communication circuit.

The input device 24 includes keys, buttons, a pointing device, a touch panel and the like, and is used to input information. For example, the display 25 is a liquid crystal display, and the display 25 displays information and data.

The processor 21 is a central processing unit (CPU) or the like, for example. The processor 21 performs various processes by executing various programs stored in the memory 22.

For example, in the case where a reservation by the user 11 is accepted by the facility 6A (that is, a reservation for the facility 6A is completed), the processor 21 performs a process of associating reservation information of the user 11 with the identification information (the user ID) of the user 11, and of storing (registering) the same in the memory 22. The user ID is used when searching for the reservation information. A unique number referred to as a reservation number or a reception number may alternatively be associated with the reservation information, instead of the user ID, and the reservation number or the reception number may be used when searching for the reservation information.

The processor 21 performs a process of generating a QR code (registered trademark; an example of a two-dimensional code) corresponding to the reservation information, and of transmitting the same to the terminal 12 of the user 11. The QR code (registered trademark) includes the user ID and the reservation information.

Furthermore, at the time of reception (check-in) of the user 11 using the terminal 3, the processor 21 receives the user ID that is read from the QR code (registered trademark) that is brought by the user 11, and the biometric information of the user 11. The processor 21 reads the reservation information corresponding to the user ID from the memory 22 and associates the biometric information with the reservation information, and also, stores (registers) the biometric information in the memory 22 as the key to be used by the user 11 in the facility 6A. That is, the processor 21 registers the biometric information of the user 11 as a key for unlocking the locked part in the facility 6A, and as a key to be used to acquire a product or a service provided in the facility 6A.

Furthermore, in the case where biometric information is received from the terminal 4 or 5, the processor 21 performs a biometric authentication process by checking the received biometric information against the biometric information that is registered in the memory 22, and transmits a result of the biometric authentication process to the terminal 4 or 5 that is the transmission source.

Additionally, a configuration is also possible where the server 2 (the processor 21) transmits the biometric information of all the users using the facility 6A to the terminals 4 and 5, and where the biometric authentication process is performed by each of the terminals 4 and 5.

Furthermore, the processor 21 performs a process of receiving a sum (the cost of a product, the fee for a service, etc.) charged by use of the facility 6A by the user 11 from the terminal 5, and of demanding payment of the sum by a payment method (such as payment by a credit card) specified in the reservation information by the user 11. For example, the processor 21 performs a process of transmitting the number of the credit card of the user 11 and the demanded sum to a computer of a credit card company (whose network address is already known).

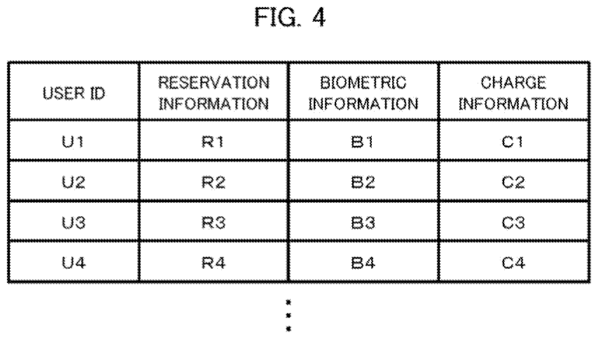

FIG. 4 illustrates an example data structure of a table that is managed by the server 2. The table is a collection of records (entries) each including the user ID, the reservation information, the biometric information, and charge information.

As described above, the reservation information includes the personal information of the user, information regarding use of the facility 6A, the biometric information, and the charge information. Information regarding use of the facility 6A includes a date of use of the facility 6A, a start time (date/time) and an end time (date/time) of use of the facility 6A, identification information of equipment and tool in the facility 6A to be used (such as the number of a room (a guesthouse) to stay), and other information pieces. The biometric information is the biometric information of the user to be used for biometric authentication, and stores one of information pieces including a fingerprint, an iris, a vein of a palm or the like, and a face. In the present embodiment, biometric authentication is performed using one type of biometric information, but two or more types of biometric information may also be used for biometric authentication. The charge information includes a use fee for the facility 6A, a total sum of costs and fees for products and services, and the like.

<Configuration of Terminal>

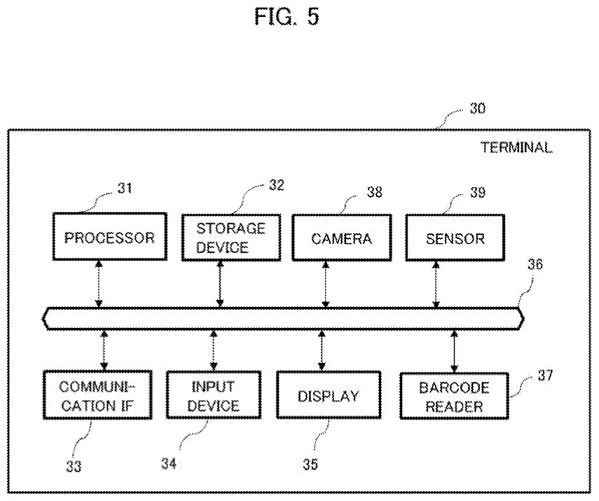

FIG. 5 illustrates an example configuration of a terminal (terminal apparatus) 30 that can be used as the terminal 3, the terminal 4, the terminal 5, the terminal 42A, and the terminal 12. As the terminal 30, general-purpose or dedicated fixed terminals including a PC and a WS, or portable terminals (mobile terminals; terminals that are portable) having a wireless communication function may be used. The portable terminal is a smartphone, a tablet terminal, a laptop personal computer (PC), a personal digital assistant (PDA), or a wearable computer, for example.

In FIG. 5, the terminal 30 includes a processor 31, a storage device (memory) 32, a communication interface (a communication IF) 33, an input device 34, a display 35, a barcode reader 37, a camera 38, and a sensor 39 that are interconnected by a bus 36.

For the processor 31, the memory 32, the communication IF 33, the input device 34, and the display 35, ones similar to the processor 21, the memory 22, the communication IF 23, the input device 24, and the display 25 described above may be applied, respectively. However, ones with different performance from those applied to the server 2 are applied depending on differences in use, purpose of use and the like.

The barcode reader 37 is used in a case where a one-dimensional code (a barcode) for the reservation information is provided to the user 11 at the time of completion of a reservation. In the case where a two-dimensional code (a QR code (registered trademark)) for the reservation information is provided to the user, the QR code (registered trademark) is read using a captured image from the camera 38. In this case, the barcode reader 37 may be omitted.

The camera 38 is used to read a two-dimensional code such as the QR code (registered trademark). Furthermore, the camera 38 is used to capture a living body, such as a face, a vein, and an iris. The sensor 39 includes a fingerprint scanner, for example, and is used to acquire a fingerprint as the biometric information. However, in the case where other than a fingerprint is used as the biometric information, the sensor 39 may be omitted.

In the case where the input device 34 includes a capacitive touch panel, the touch panel is used as a sensor for detecting the user 11 when the user 11 brings a finger into contact or into proximity. The terminal 30 may alternatively include a sensor (a capacitive sensor, a photosensor, etc.) for detecting the user 11, separately from the touch panel.

The processor 31 performs various processes by executing various programs stored in the memory 32. For example, the processor 31 of the terminal 30 operating as the terminal 3 performs a process of reading information in the one-dimensional or two-dimensional code brought by the user, by using the camera 38 or the barcode reader 37. Furthermore, the processor 31 performs a process of acquiring the biometric information from the user 11 by using the camera 38 or the sensor 39. Moreover, the processor 31 performs a process of transmitting the information in the one-dimensional or two-dimensional code and the biometric information to the server 2.

Furthermore, the processor 31 of the terminal 30 operating as the terminal 4 performs a process of acquiring the biometric information from the user 11 and transmitting the same to the server 2, and of receiving a result of biometric authentication from the server 2. Furthermore, in the case where the result of biometric authentication is success (OK), the processor 31 performs a process of unlocking the locked part corresponding to the terminal 4.

Like the processor 31 of the terminal 4, the processor 31 of the terminal 30 operating as the terminal 5 performs a process of transmitting the biometric information acquired from the user 11 to the server 2, and of receiving a result of biometric authentication. Furthermore, in the case where the result of biometric authentication is success, the processor 31 performs a process for achieving a state where products and services can be provided. For example, the process for achieving the state where products and services can be provided is a process of validating product selection buttons of the automatic vending machine 43, or a process of causing the display 35 to perform display indicating that products and services can be provided and of notifying a clerk that products and services can be provided to the user 11. That provision is allowed may be notified to the clerk through sound or vibration. Furthermore, the processor 31 performs a process of transmitting the cost of a product and the fee for a service to the server 2, and of causing the cost and the fee to be billed (charged).

Additionally, the configuration of the terminal 30 may be applied to the terminal 12 of the user 11. The processor 31 of the terminal 30 operating as the terminal 12 performs a process of providing the user 11 with an environment where the reservation information can be edited using the input device 34 and the display 35, and a process of transmitting the reservation information to the network 1 using the communication IF 33, and of receiving the one-dimensional or two-dimensional code from the network 1, and moreover, performs a process of calling up the one-dimensional or two-dimensional code on the display 35 according to an operation by the user 11.

Additionally, a plurality of CPUs or a multicore CPU may be used as each of the processor 21 and the processor 31. At least a part of processes that are performed by the CPU may be performed by a processor other than the CPU, such as a digital signal processor (DSP) or a graphical processing unit (GPU). Furthermore, at least a part of processes that are performed by the CPU may be performed by a dedicated or general-purpose integrated circuit (hardware) such as an application specific integrated circuit (ASIC) or a field programmable gate array (FPGA), or a combination of the processor and the integrated circuit. Such a combination is referred to as a microcontroller (MCU), a system-on-a-chip (SoC), a system LSI, or a chipset, for example.

<Process by Server>

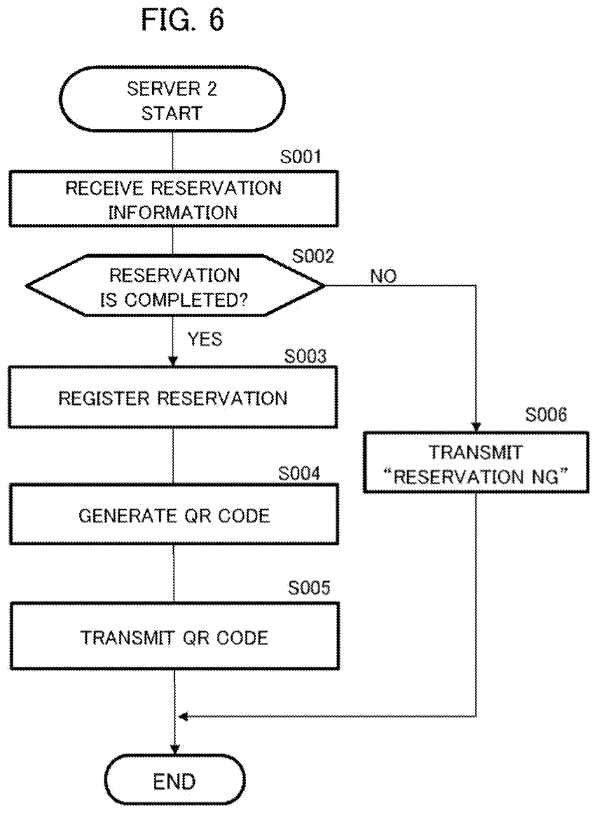

FIG. 6 is a flowchart illustrating an example process that is performed by the processor 21 of the server 2. A description is given taking the facility 6 (an accommodation facility) illustrated in FIG. 2 as the facility 6A.

In step S001, the processor 21 of the server 2 receives the reservation information. The reservation information includes at least the personal information of the user 11, and the date of stay. A check-in time and a check-out time of the facility 6A (corresponding to the start time and the end time of use of the facility 6A) are set in advance. Alternatively, the user 11 may be allowed to specify the check-in time and the check-out time.

In step S002, the processor 21 determines whether the reservation is completed. For example, information indicating a vacancy state of the guesthouse 50 of the facility 6A is stored in the memory 22, and whether there is a vacant guesthouse 50 on a desired date of stay included in the reservation information is determined. In the case where there is a vacant guesthouse 50, the processor 21 determines completion of the reservation, and the process proceeds to step S003.

By contrast, in the case where it is determined in step S002 that there is no vacant guesthouse 50, the process proceeds to step S006, and the processor 21 transmits information indicating reservation NG to the terminal 12 via the communication IF 23. The process by the server 2 is then ended.

Additionally, in step S002, instead of the process described above, the server 2 (the processor 21) may ask a computer other than the server 2, that manages a reservation state of the guesthouse 50, for vacancy information, and may receive a reply including information indicating vacancy/no vacancy. In this case, if there is a vacancy, identification information of the vacant guesthouse 50 (such as a number assigned to the guesthouse 50) is further received.

In step S003, the processor 21 performs reservation registration. That is, the processor 21 associates the reservation information including the personal information of the user, the date of stay, the identification information of the guesthouse 50 to be rented, and the check-in time and the check-out time that are set in advance with the user ID of the user 11, and performs registration in the memory 22, for example. A storage location may be other than the memory 22 as long as access by the processor 21 is possible.

In step S004, the processor 21 generates a QR code (registered trademark) that is an example of the one-dimensional or two-dimensional code. The QR code (registered trademark) includes the user ID of the user 11 and the reservation information. However, it suffices if the QR code (registered trademark) includes at least the user ID of the user 11.

In step S005, the processor 21 transmits the QR code (registered trademark) to the terminal 12 of the user 11 via the communication IF. When the process in S005 is ended, the process by the server 2 is ended.

In this manner, the user 11 wishing to use the facility 6A transmits reservation request information for making a reservation for using the facility 6A to the network 1, by using the terminal 12 that the user 11 manages. In the case where the reservation request information is accepted by the server 2, the reservation information is registered in the server 2 to be managed. In the case where the reservation by the user 11 is accepted, the server 2 transmits the QR code (registered trademark) and the like to the terminal 12 of the user 11.

The user 11 visits the facility 6A on the date of use of the facility 6A. When the start time of use (the check-in time) is close, the vehicle 53 stops at a boarding location near the entrance 61 of the facility 6A. The user 11 gets in the vehicle 53. The terminal 3 for reception is provided in the vehicle 53. The user 11 performs a procedure for reception (check-in) by operating the terminal 3.

<Process by Terminal 3>

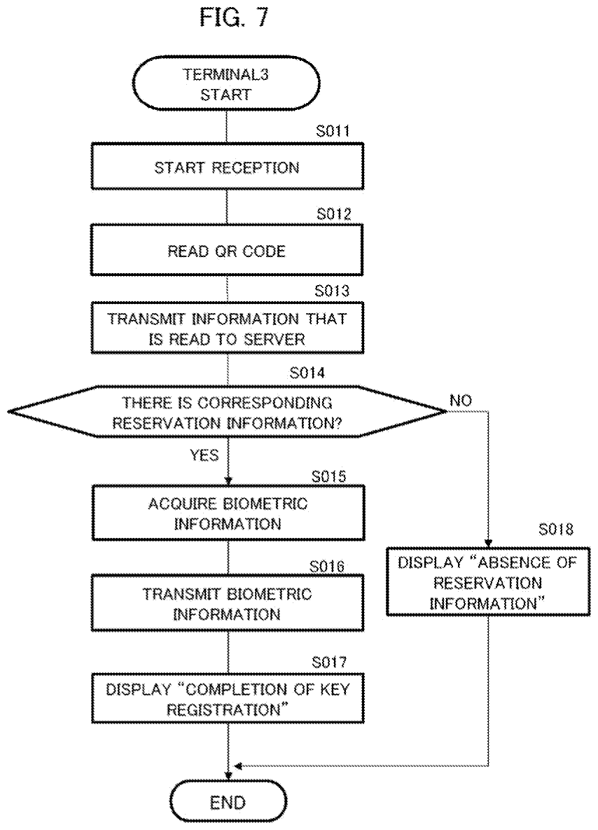

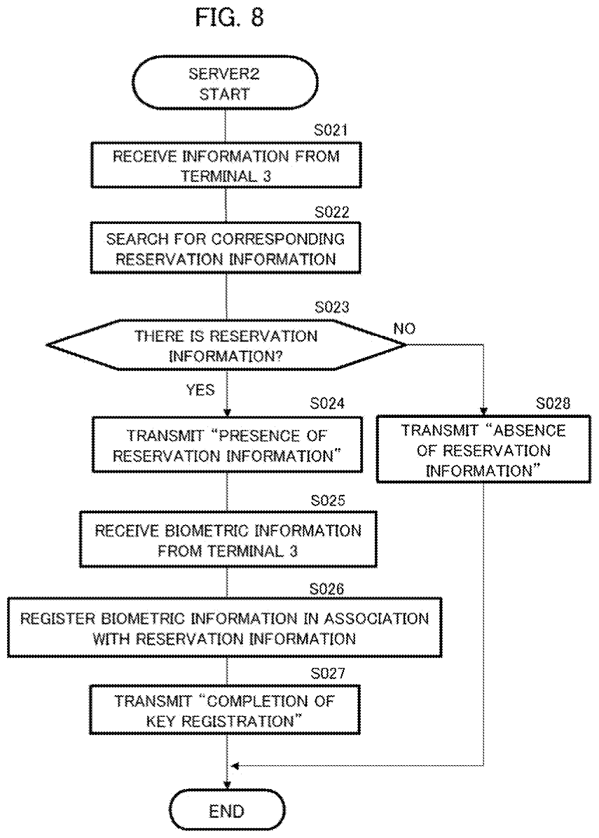

FIG. 7 is a flowchart illustrating an example process by the processor 31 of the terminal 30 operating as the terminal 3 for reception. FIG. 8 is a flowchart illustrating an example process by the processor 21 of the server 2 performing exchange with the terminal 3.

In step S011 in FIG. 7, the processor 31 of the terminal 3 starts a process in the case where an input for starting a reception process using the input device 34 is received from the user 11, for example.

In step S012, the processor 31 activates the camera 38, and also, displays, on the display 35, a screen for reading the QR code (registered trademark), and urges the user 11 to cause the QR code (registered trademark) that is provided in advance to be read. The user 11 calls up the QR code (registered trademark) on the screen of the terminal 12, and causes the terminal 3 to read the QR code (registered trademark). The QR code (registered trademark) may be a hard copy that is printed on a sheet such as paper.

In step S013, the processor 31 acquires the user ID and the reservation information by reading the QR code (registered trademark), and transmits the user ID and the reservation information to the server 2 via the communication IF 33.

As illustrated in FIG. 8, the processor 21 of the server 2 receives the user ID and the reservation information from the terminal 3 (step S021). Then, the processor 21 searches for reservation information matching the user ID and the reservation information from the memory 22 (step S022). At this time, the processor 21 determines whether there is reservation information corresponding to the user ID, and in the case where presence of the reservation information is determined, determines whether contents of the reservation information match. Then, in the case where the contents of the reservation information match, retrieval of matching reservation information is determined; otherwise, it is determined that matching reservation information is not retrieved.

Alternatively, instead of the configuration described above, presence of the matching reservation information may be determined based on presence of the corresponding reservation information. In this case, it suffices if the QR code (registered trademark) includes at least information to be used for a search for the reservation information (that is, information that is linked to the reservation information), such as the user ID, and the reservation information does not have to be included.

The processor 21 determines whether matching reservation information is retrieved (step S023). In the case where retrieval of the reservation information is determined, the processor 21 transmits information indicating presence of the reservation information to the terminal 3 via the communication IF 23 (step S024).

By contrast, in the case where it is determined that the reservation information is not retrieved, the processor 21 transmits information indicating absence of the reservation information to the terminal 3 via the communication IF 23 (step S028).

At the terminal 3, the processor 31 determines, in step S014, whether there is the corresponding reservation information, based on the information from the server 2 indicating presence/absence of the reservation information. In the case where presence of the reservation information is determined, the process proceeds to step S015; otherwise, the process proceeds to step S018.

In the case where the process proceeds to step S018, the processor 31 displays, on the display 35, information indicating that there is no reservation information, and the process illustrated in FIG. 7 is ended.

By contrast, in the case where the process proceeds to step S015, the processor 31 performs a process of acquiring predetermined biometric information. In the present embodiment, face information is acquired as an example of the biometric information, and face authentication is performed as biometric authentication. Accordingly, the terminal 3 provides an environment where a face image of the user 11 is to be captured by the camera 38, and acquires the biometric information by capturing the face of the user 11.

In step S016, the processor 31 transmits the face image as the biometric information that is acquired in step S015 to the server 2. At the server 2, the face image as the biometric information, from the terminal 3, is received (step S025 in FIG. 8).

The processor 21 of the server 2 generates the face information to be used for biometric authentication (face authentication) from the face image, associates the face information (an example of the biometric information) with the user ID and the reservation information, and registers (stores) the face information in the memory 22 as key information to be used in the facility 6A (step S026). A storage location of the face information may be a storage medium, other than the memory 22, that can be accessed by the processor 21.

In step S027, the processor 21 transmits information indicating that key registration is complete, via the communication IF 23. At the terminal 3, the processor 31 receives the information indicating that key registration is complete, and displays the same on the display 35 (step S017). The reception process (the check-in process) is performed in such a manner.

The user 11 gets off when the vehicle 53 arrives in front of the guesthouse 50 where the user 11 is to stay. The user 11 performs face authentication using the terminal 4 (the terminal 30 operating as the terminal 4) installed on a wall of the guesthouse 50, near the door 50A of the entrance of the guesthouse 50.

### Example Process by Terminal 4

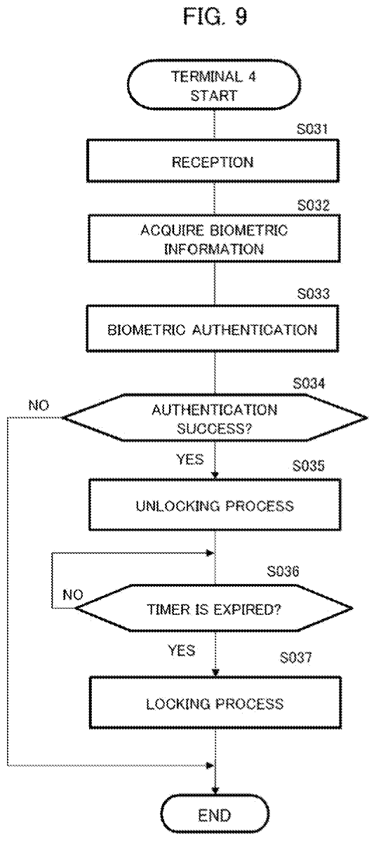

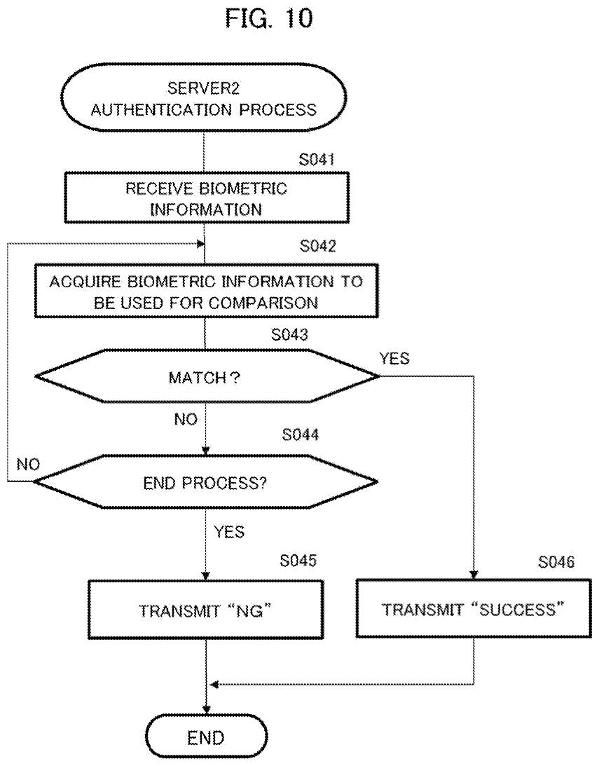

FIG. 9 is a flowchart illustrating an example process by the processor 31 of the terminal 30 operating as the terminal 4 for biometric authentication, and FIG. 10 is a flowchart illustrating an example process by the processor 21 of the server 2 performing exchange with the terminal 4.

In step S031, the processor 31 of the terminal 4 starts processing when the user operates the input device 34 of the terminal 4. For example, when the user 11 brings a hand close to the display 35 of the terminal 4, a touch panel of the display 35 detects a change in capacitance, and the processor 31 starts processing. An operation to start processing may be performed in such a contactless manner, or may be performed through contact. Detection of the user 11 may be performed by a photosensor or the like other than the touch panel.

In step S032, the processor 31 acquires the biometric information. For example, the processor 31 activates the camera 38, and urges the user 11 to face the camera 38. At this time, the processor 31 displays a face that is captured by the camera 38 on the display 35, and urges the user 11 to be captured by the camera 38 in a state suitable for face authentication. In this manner, the camera 38 captures the face of the user 11, and the processor 31 acquires the face image as the biometric information.

In step S033, the processor 31 performs face authentication as biometric authentication. That is, the processor 31 transmits the face image of the user 11 captured in step S032 to the server 2, together with the user ID, and receives a result of face authentication from the server 2.

The server 2 receives the face image transmitted from the terminal 4 as the biometric information, and generates, from the face image, face information to be used for face authentication (FIG. 8, step S041). In step S042, the processor 21 specifies one record from the table (FIG. 4) stored in the memory 22, and acquires face information that is the biometric information in the record, as a comparison target to be checked against the received face information.

In step S043, the processor 21 performs biometric authentication, that is, matching of the face information pieces, and determines whether the face information pieces match or not. In the case where the face information pieces are determined to match, the processor 21 transmits information indicating success of face authentication to the terminal 4, together with the user ID (step S046), and ends the process.

By contrast, in the case where the face information pieces do not match, the processor 21 determines whether checking is performed for all the face information pieces in the table (step S044). In the case where it is determined that checking is not performed for all the face information pieces, the process returns to step S042, and the next face information is acquired from the table.

In the case where it is determined that checking is complete for all the face information pieces, the process proceeds to step S045, and the processor 21 transmits information indicating face authentication NG to the terminal 4, and ends the process.

At the terminal 4, the processor 31 determines, in step S034 in FIG. 7, whether the result of biometric authentication received from the server 2 is success or not. In the case where the result of authentication is determined to be success, the process proceeds to step S035; otherwise (in the case where NG is determined), the process is ended.

In step S035, the processor 31 performs an unlocking process. That is, the processor 31 unlocks an electromagnetic lock of the door 50A. Furthermore, in the case where the door 50A is an automatic door, the processor 31 causes the door 50A to perform an opening operation for a specific period of time by controlling an actuator that performs open/close operation of the door 50A.

In step S036, the processor 31 starts measurement by a timer for a predetermined period of time, and when the timer expires, the process proceeds to step S037, and the door 50A is locked by operation of the electromagnetic lock. The process is then ended.

Additionally, in the case where the face information pieces match (YES in S043), whether the user is the user of the guesthouse 50 in question may be determined, and if positive, the process may proceed to step S046, and if negative, NG may be issued. This prevents a user who is not the user of the guesthouse 50 from entering the guesthouse 50 even if the user is the user of the facility 6A, unless the door 50A is opened by the actual user. Security may thus be increased. Furthermore, the server 2 or the terminal 4 may link and record a log regarding unlocking of the door 50A with the user ID of the user for whom face authentication succeeded.

In this manner, the user 11 may unlock the door 50A through face authentication even if the key is not handed over at the time of check-in. The processes by the terminal 4 and the server 2 illustrated in FIGS. 9 and 10 are also applied to the terminal 4 corresponding to each of the gate 52A of the tennis court 52, the door 45A of the changing room 45, the door 46A of the communal bathroom 46, and the door 47A of the lounge 47. Accordingly, the user 11 does not need to carry a physical key at the time of using the tennis court 52, the changing room 45, the communal bathroom 46, and the lounge 47.

### Example Process by Terminal 5

In the case of purchasing a product (such as a drink) from the automatic vending machine 43, using the locker 49, and receiving a service at the shop 48, for example, the user 11 may receive the product or provision of the service by using the terminal 5 corresponding to each of the automatic vending machine 43, the locker 49, and the shop 48.

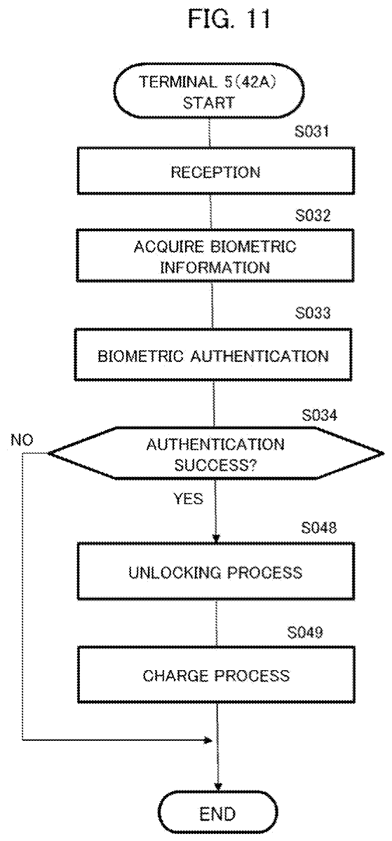

FIG. 11 is a flowchart illustrating an example process by the processor 31 of the terminal 30 operating as the terminal 5 for biometric authentication.

The processes from step S031 to S034 are the same as the processes by the terminal 4 illustrated in FIG. 9, and redundant description is omitted. However, in relation to the terminal 5 corresponding to the locker 49, the user 11 inputs, in step S031, the number of the locker 49 that the user 11 wants to use.

In an unlocking process in step S048, an operation unique to each of the automatic vending machine 43, the locker 49, and the shop 48 is performed. The processor 31 of the terminal 5 corresponding to the automatic vending machine 43 sets, in the unlocking process, a state of the automatic vending machine 43 to a state where the user 11 is enabled to purchase any product (a state where money that is greater than the cost of a most expensive product is put in the automatic vending machine 43), and a state is thus achieved where the user 11 may select and purchase a desired product by pressing a purchase button for the desired product.

Furthermore, the processor 31 of the terminal 5 corresponding to the locker 49 unlocks the electromagnetic lock of the locker 49 of the number specified by the user 11, and places the door of the locker 49 in an open state. The user 11 may thus place belongings in the locker 49. When the user 11 closes the door, the processor 31 performs a locking operation, that is, the locker 49 is electromagnetically locked.

Furthermore, the processor 31 of the terminal 5 corresponding to the shop 48 displays, on the display 35, that a service can be provided to the user 11, and informs the clerk of the shop 48 that the service can be provided. The clerk thus provides the service to the user 11.

In step S049, the processor 31 performs a charge process. That is, the processor 31 transmits to the server 2, together with the user ID, charge-related information regarding the cost of the product, the fee for using the locker 49, or the fee for the provided service. In the case where information about the cost and the fee is managed by the server 2, the processor 31 transmits to the server 2, as the charge-related information, information indicating each of the product, use of the locker, and the service. By contrast, in the case where information about the cost and the fee (a charged amount) is not managed by the server 2, information indicating the cost and the fee (the charged amount) is transmitted together with the information indicating each of the product, the number of the locker 49, and the service, as the charge-related information.

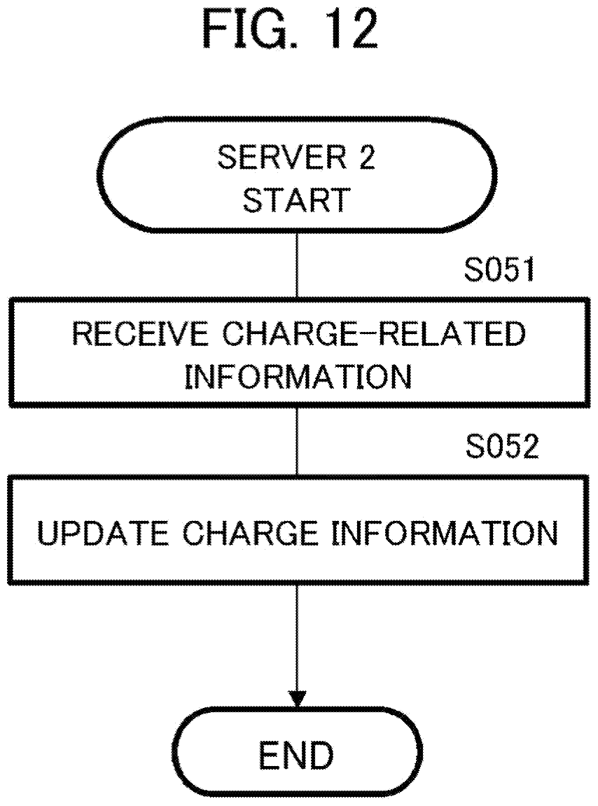

As illustrated in FIG. 12, the server 2 receives the charge-related information (step S051), reads the charge information corresponding to the user ID from the table, and updates the charge information using the charge-related information. In the case where the charge-related information includes the charged amount, the charge information is updated by adding the current charged amount to a cumulative sum of the charged amount indicated by the charge information (step S052). In the case where the charge-related information does not include the charged amount, the processor 21 of the server 2 calculates the charged amount for the product, the number of the locker 49, or the service, using information about the cost and the fee stored in the memory 22, and adds the current charged amount to the cumulative sum of the charged amount indicated by the charge information. The charged amount is assumed to include tax, and is the amount to be paid through payment by a credit card or the like.

In the case where the terminal 42A serves as the terminal 3, the terminal 30 operating as the terminal 42A performs the processes in FIGS. 7 and 8. By contrast, in the case where the terminal 42A serves as the terminal 5, the processes in FIGS. 10, 11 and 12 are performed.

### Effects of Embodiment

The server 2 as the information processing apparatus according to the embodiment acquires the biometric information (the face information) of the user 11 at the time of reception for use of the facility 6 (6A) by the user 11. Furthermore, the server 2 associates the biometric information of the user 11 with information indicating the user 11 (the reservation information). Furthermore, the server 2 registers the biometric information of the user 11 as a key to be used in the facility 6. Accordingly, a physical key to be used by the user 11 in the facility 6 does not have to be handed over, and the user 11 does not have to carry such a key inside the facility. Furthermore, occasions of contact with a person, such as at the time of handing over of a key, may be reduced.

The processor 21 of the server 2 registers the biometric information of the user 11 as a key for unlocking the locked part in the facility 6, and a key to be used to acquire a product or a service that is provided in the facility 6. The user 11 may thus use the biometric information in the facility 6 to unlock the locked part, and to purchase a product or a service.

In the embodiment, the controller (the processor 21) of the server 2 acquires information indicating the user, that is read by a reading device (the camera 38 or the barcode reader 37 of the terminal 3) from a one-dimensional code (a barcode) or a two-dimensional code (a QR code (registered trademark)) carried by the user 11. Accordingly, it is possible to save, for the user, the trouble of having to write personal information and the like at the reception of the facility 6. Alternatively, the processor 21 may acquire the information indicating the user 11 from the memory 22, a universal serial bus (USB) memory or the like storing the information indicating the user 11.

Furthermore, in the embodiment, the processor 21 of the server 2 performs biometric authentication for the user 11 by checking the biometric information of the user 11 detected from the user 11 at a location of use of the key (such as in front of the door 50A, the door 52A, the locker 49, and the automatic vending machine 43) against the biometric information of the user 11 that is registered. High-security personal authentication may thus be performed. Alternatively, the processor 21 of the server 2 may transmit the biometric information of the user 11 that is registered, to a checking device (the terminal 4 or the terminal 5) for biometric information that is installed at the location of use of the key, and the processor 31 of the terminal 4 or the terminal 5 may perform checking of the biometric information pieces (biometric authentication).

Furthermore, in the present embodiment, the processor 21 of the server 2 may acquire the biometric information of the user 11 who is on board the vehicle 53, from the terminal 3 that is on the vehicle 53 that travels in the facility. Accordingly, reception (registration of the biometric information) may be completed while the user 11 is moving to the guesthouse 50.

Additionally, instead of the configuration of the embodiment, the terminal 3 may associate the information indicating the user 11 that is read from the QR code (registered trademark) and the biometric information that is acquired from the user 11 and transmit the same to the server 2, and the server 2 may register, in the memory 22, the biometric information and the information indicating the user 11 that are associated with each other, and registration of the key may thus be performed.

<Others>

The embodiment described above is merely an example, and the present disclosure may be changed as appropriate within the scope of the disclosure.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiment described above to a computer, and by one or more processors of the computer reading out and executing the programs. Such computer programs may be provided to the computer by a non-transitory computer-readable storage medium that can be connected to a system bus of the computer, or may be provided to the computer via a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.). Furthermore, the non-transitory computer-readable storage medium may include read-only memories (ROMs), random access memories (RAMs), EPROMs, EEPROMs, magnetic cards, flash memories, optical cards, and any type of medium suitable for storing electronic instructions.

What is claimed is:

1. An information processing apparatus comprising a controller configured to:
acquire biometric information of a user at a time of reception for use of a facility by the user;
associate the biometric information of the user with information indicating the user; and
register the biometric information of the user as a key to be used in the facility.

2. The information processing apparatus according to claim 1, wherein the controller registers the biometric information of the user as a key for unlocking a locked part in the facility.

3. The information processing apparatus according to claim 1, wherein the controller registers the biometric information of the user as a key to be used to acquire a product or a service provided in the facility.

4. The information processing apparatus according to claim 1, wherein the controller acquires the information indicating the user that is read by a reading device from a one-dimensional code or a two-dimensional code carried by the user.

5. The information processing apparatus according to claim 1, wherein the controller checks biometric information of the user that is detected from the user at a location of use of the key against the biometric information of the user that is registered.

6. The information processing apparatus according to claim 1, wherein the controller transmits the biometric information of the user that is registered, to a checking device for biometric information that is installed at a location of use of the key.

7. The information processing apparatus according to claim 1, wherein the facility includes at least one of an accommodation facility, a fitness facility, a play facility, an entertainment facility, a library, a museum, and a concert hall.

8. The information processing apparatus according to claim 1, wherein the controller acquires the biometric information of the user from the user who is on board a vehicle that travels in the facility.

9. The information processing apparatus according to claim 1, wherein the biometric information is at least one of a fingerprint, a vein, an iris, and a face.

10. The information processing apparatus according to claim 2, wherein the locked part includes at least one of a door, a gate, a window, equipment, and a tool in the facility.

11. An information processing method comprising:
acquiring, by an information processing apparatus, biometric information of a user at a time of reception for use of a facility by the user;
associating, by the information processing apparatus, the biometric information of the user with information indicating the user; and
registering, by the information processing apparatus, the biometric information of the user as a key to be used in the facility.

12. The information processing method according to claim 11, wherein the information processing apparatus registers the biometric information of the user as a key for unlocking a locked part in the facility.

13. The information processing method according to claim 11, wherein the information processing apparatus registers the biometric information of the user as a key to be used to acquire a product or a service provided in the facility.

14. The information processing method according to claim 11, wherein the information processing apparatus acquires the information indicating the user that is read by a reading device from a one-dimensional code or a two-dimensional code carried by the user.

15. The information processing method according to claim 11, wherein the information processing apparatus checks biometric information of the user that is detected from the user at a location of use of the key against the biometric information of the user that is registered.

16. The information processing method according to claim 11, wherein the information processing apparatus acquires the biometric information of the user from the user who is on board a vehicle that travels in the facility.

17. A non-transitory storage medium storing a program for causing a computer to:
acquire biometric information of a user at a time of reception for use of a facility by the user; and
transmit the biometric information of the user to an apparatus that associates the biometric information of the user with information indicating the user, and that registers the biometric information of the user as a key to be used in the facility.

18. The non-transitory storage medium according to claim 17, wherein the program causes the computer to acquire the biometric information of the user that is registered as at least one of a key for unlocking a locked part in the facility and a key to be used to acquire a product or a service provided in the facility.

19. The non-transitory storage medium according to claim 17, wherein the program causes the computer to acquire the information indicating the user that is read by a reading device from a one-dimensional code or a two-dimensional code carried by the user.

20. The non-transitory storage medium according to claim 17, wherein the program causes the computer to acquire the biometric information of the user from the user who is on board a vehicle that travels in the facility.
